(19) United States
(12) Patent Application Publication
(10) Pub. No.: US 2025/0339978 A1
(43) Pub. Date: Nov. 6, 2025

(54) Adjustable Gripping And Handling Device

(71) Applicant: Albert William Francis Fourie, Chatswood (AU)

(72) Inventor: Albert William Francis Fourie, Chatswood (AU)

(21) Appl. No.: 18/655,292

(22) Filed: May 5, 2024

(51) Int. Cl. B25J 15/06

(52) U.S. Cl. CPC B25J 15/0683

(57) ABSTRACT

An adjustable gripping and handling device is disclosed for material handling providing an adjustable gripping that addresses need for efficient and versatile gripping using combination of mechanical gripping and vacuum suction. The device comprises of a plurality of members including a horizontal member, a first vertical member, and a second vertical member. Anterior end of the first vertical member and the second vertical member is connected to the horizontal member via a slider mechanism, and posterior end of the first vertical member and the second vertical member is attached with a hydraulic gripper via a chain rotation drive mechanism. The hydraulic gripper is configured with a plurality of individual mechanical clamp parts, which houses a sliding part configured with floating vacuum cup foam and a vacuum port for enabling mechanical and vacuum gripping to grip diverse product.

### CROSS-REFERENCE TO RELATED APPLICATION

This application is a continuation-in-part of U.S. patent application Ser. No. 18/382,522 entitled “Precast Concrete Pipes De-Moulder” and filed on Oct. 22, 2023. The above-identified application is incorporated herein by reference in its entirety.

### BACKGROUND

### Field of Invention

The present invention relates to a material handling and automation device and more particularly to an adjustable gripping and handling device that addresses the need for efficient and versatile gripping using combination of mechanical gripping and vacuum suction capabilities to offer a comprehensive solution for handling a wide range of products in industrial and commercial settings.

### Description of Related Arts

There are plenty of technologies that are already in use for material handling, which are mainly based on two ways to grip the products that are to be lifted and transported. The two different ways utilized by the device for gripping are mainly mechanical gripping and vacuum gripping. The mechanical grippers are typically equipped with jaws or fingers, allowing them to form a lock over a protrusion or indentation in view of clamping the product. In this case, the friction between the gripper surface and the surface of the product provides the gripping force to prevent the product from sliding out of the grippers. For example, in case the grippers are to be used for handling the pre-cast concrete product, the grippers are pushed onto the product via hydraulic cylinders. The effective clamping force is the pressure applied via the gripping pads multiplied by the coefficient of friction between the gripper material and concrete.

The limitation of the mechanical grippers lies in handling the products that are relatively heavy and the allowed mechanical force that may be applied to the product may be limited by the strength of the product. For example, the concrete during the manufacturing process may not be up to full strength yet, or the products that have a thin or weaker wall, which limits the force that can be applied without damaging the product. Therefore, the effective gripping force is also limited. Further, many industries legally prescribe safety factors for the safe handling of the products. For example, pre-cast concrete industry, limits vary from a factor of safety of 2 to 3; and a 1200 NB product of 70 mm wall thickness and 2.4 long may only have an allowed gripping force of 7 kN to prevent damage to the product. If this force is applied via PU or rubber gripper pads, the safety factor is about 1.7, which falls short of the required factor.

The other way to ways to grip the products is vacuum grippers which typically use vacuum cups or pads that are placed against the products surface and a vacuum pressure is applied for gripping the product. The vacuum grippers are generally utilized for light products, whereas heavy products require substantial size of the vacuum pads to produce enough force to clamp the product safely. Due to physical constraint on the product or in the manufacturing process, this is not much desirable.

EP2735409A1 relates to a gripping device for gripping objects, which has two gripping units moved between a releasing position and a gripping position for seizing planar objects. The gripping units comprise pneumatic gripping drives, over which the working movement between the gripping position and an open position is realized. The gripping units comprise a base unit, which comprises a fastening interface for releasably fastening gripping elements. The respective grab drive is arranged on a board the gripper elements. Although, the cited prior art is utilized for gripping different shapes of products in a safe manner. However, the cited document fails to utilize dual gripping mechanism that is mechanical gripping and vacuum gripping to prevent chances of slipping of product along with providing aid in turning and rotation of product as disclosed by the present invention.

U.S. Pat. No. 4,367,891A discloses industrial robot for gripping workpieces of diverse shape comprises at least one finger preferably two arranged for pivotal movement on respective sides of the work-piece. Each finger has at least one work-piece engagement member or joint which is movable thereon. Fluid pressure operated means are connected to the work-piece engagement member or joint so that it is moved outwardly from the associated finger to engage the work-piece and to be locked in the engaged position so that it will reengage in the same position after the finger is shifted relative to the work-piece to reengage it. Although, the cited prior art is utilized for gripping different shapes of product in a safe manner. However, the cited document fails to utilize dual gripping mechanism that is mechanical gripping and vacuum gripping to prevent chances of slipping of product along with alarming the user in case of gripping system failure as disclosed by the present invention.

Conventionally, there exist several systems and devices that facilitate gripping of different shapes of object. However, these systems and devices lack in ensuring the safety of the object by preventing accidental dropping of the object in case, mechanical gripping force fails to hold the object.

Therefore, there exist a need to develop a gripping device that utilizes combination of mechanical gripper and vacuum suction to hold variety of shapes of product that is to be lifted, rotated and transported while preventing chances of damage to the product.

### OBJECTS

The principal object of the present invention is to overcome the disadvantages of the prior art.

The object of this invention is to provide an adjustable gripping and handling device designed to handle various products by combining mechanical gripper and vacuum suction capabilities.

Another object of the present invention is to provide a device that is suitable for lifting products of different sizes and shapes efficiently and securely.

Another object of the present invention is to provide a device that is capable of turning and rotating the product in user-desired orientation.

Yet another object of the invention is to prevent accidental dropping of the product due to technical fault by utilizing combination of mechanical gripping and vacuum gripping and alarming the operator.

The foregoing and other objects, features, and advantages of the present invention will become readily apparent upon further review of the following detailed description of the preferred embodiment as illustrated in the accompanying drawings.

### SUMMARY

This present invention relates to an adjustable gripping and handling device that handles various size and shape of products by gripping the products that are to be lifted, rotated and transported in an efficient and secure manner along with ensuring safety of the product.

In accordance with a preferred embodiment of the present invention, the adjustable gripping and handling device comprises a plurality of members, which includes a horizontal member, a plurality of vertical members including a first vertical member and a second vertical member. The horizontal member has a first end and a second end. In the embodiment, the each of the plurality of vertical members comprises an anterior end and a posterior end, wherein the anterior end of the plurality of vertical member is connected to the horizontal member via a slider mechanism and the posterior end of the plurality of vertical member comprises a hydraulic gripper.

The slider mechanism allows for adjusting gap between the first vertical member and the second vertical member according to the size of a product to be lifted. In one embodiment of the present invention, the slider mechanism includes a slider, rails or tracks, bearings, fasteners, actuator, and guides. Wherein, the components associated with the slider mechanism work together to enable smooth and controlled movement of the first vertical member and the second vertical member towards and away from each other.

In one embodiment of the present invention, the proposed device comprises an ultrasonic sensor and/or laser acuity sensor for automatic detection of the size of the product.

In another embodiment of the present invention, the size of the product is determined manually by the operator of the gripping device and accordingly adjustment in the gap between the first vertical member and the second vertical member is made.

In yet another embodiment of the present invention, the size of the product may be determined by artificial intelligence and the device may be operated by computer instructions.

In the embodiment, the hydraulic gripper is configured with a chain rotation drive mechanism, wherein each of the hydraulic gripper is configured with a plurality of mechanical clamp parts. Further each of the plurality of mechanical clamp parts has a housing to accommodate a free floating sliding part. Each of the hydraulic gripper uses pressurized fluids to move a piston associated with the hydraulic gripper and the movement of the piston, transfers the force to the gripper jaws in view of opening and closing the jaws.

In one of the embodiments, the chain rotation drive mechanism comprises of a pair of hydraulic piston connected to a hydraulic system, a loop of chain, a sprocket and an axle associated with the pair of hydraulic grippers and configured with the sprocket. The hydraulic system's valve and controller regulate the flow and direction of hydraulic fluid to the pistons. When the pressurized hydraulic fluid is supplied to the pistons, they extend or retract depending on the direction of fluid flow. Each piston is attached to one end of the loop of the chain so that the extension and retraction of the pistons pull or release the chain accordingly. The links associated with the loop of the chain are engaged with teeth of the sprocket and further the sprocket is connected to the axle of the hydraulic gripper. When hydraulic fluid is supplied to the piston, one piston extends while other retracts, causing the loop of chain to move in one direction.

Moreover, the each of the hydraulic grippers is configured with a plurality of individual mechanical clamp parts having a contact surface fabricated with gripping pads. The gripping pads are made up of rubber or polyurethane (PU) to enhance the grip on the product. Furthermore, the plurality of mechanical clamp parts is configured with the pair of hydraulic grippers via universal joints. Wherein, the universal joints allow movement of the plurality of individual mechanical clamp parts in a pre-defined range in order to enable alignment of contact surface in the direction of the product that is to be gripped.

The mechanical clamp parts house a sliding part configured with floating vacuum cup foam. This foam provides a stable and adaptable surface for vacuum suction. Further, each sliding part is configured with a vacuum port connected to a vacuum pump or pre-charged tank. This enables the device to switch between mechanical gripping and vacuum suction as required for handling different types of products. In the embodiment, the plurality of sliding parts freely moves within the housing of the mechanical clamp parts. In the embodiment, the movement is forward movement.

In one embodiment of the present invention, each vertical member at its posterior end has a hydraulic gripper. The pair of hydraulic grippers at both the plurality of vertical members is integrated with a product slip detector. The pair of hydraulic grippers applies a certain amount of force to securely hold the product and the force that is being applied is measured continuously by the force sensor, which is transferred to a microcontroller provided within the device. In case the microcontroller determines that the measured force is below as compared with a pre-determined threshold value and pre-saved in the database connected to the microcontroller, the microcontroller activates the alarm unit to alert operators.

In one embodiment of the present invention, the microcontroller directs the pair of hydraulic grippers for corrective actions, such as adjusting the grip force. In another embodiment of the present invention, the microcontroller halts the operation until the issue is resolved.

According to another embodiment of the present invention, the adjustable gripping and handling device is capable of activation of mechanical gripping and vacuum suction gripping at the same time as required for handling different types of products.

While the invention has been described and shown with particular reference to the preferred embodiment, this will be apparent that variations might be possible that would fall within the scope of the present invention.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below.

To further clarify advantages and features of the present invention, a more particular description of the invention will be rendered by reference to specific embodiment thereof, which is illustrated in the appended drawings. It is appreciated that these drawings depict only typical embodiments of the invention and are therefore not to be considered limiting of its scope. As will be appreciated, other embodiments of the present invention are possible utilizing, alone or in combination, one or more of the features set forth above or described in detail below.

### BRIEF DESCRIPTION OF THE DRAWINGS

These and other features, aspects, and advantages of the present invention will become better understood with regards to the following description, appended claims, and accompanying drawings where:

FIG. 1 illustrates a perspective view of an adjustable gripping and handling device holding a typical concrete product according to embodiments of the present invention disclosed herein;

FIG. 2 illustrates a perspective view of the proposed device holding the typical concrete product in different orientation according to embodiments of the present invention disclosed herein;

FIG. 3 illustrates a side view of the proposed device holding the product, indicating a chain rotation drive mechanism according to embodiments of the present invention disclosed herein;

FIG. 4 illustrates a perspective view of the chain rotation drive mechanism according to embodiments of the present invention disclosed herein;

FIG. 5 illustrates a perspective view of the chain rotation drive mechanism, indicating extension and retraction of the pistons that pull or release the chain according to embodiments of the present invention disclosed herein;

FIG. 6 illustrates a perspective view of the proposed device indicating bigger gap of a first vertical member and a second vertical member according to embodiments of the present invention disclosed herein;

FIG. 7 illustrates a perspective view of the proposed device indicating closer gap of the first vertical member and a second vertical member at different location on a horizontal member according to embodiments of the present invention disclosed herein;

FIG. 8 illustrates a perspective view of the proposed device, indicating a forklift carry beam with anti-side swing support according to embodiments of the present invention disclosed herein;

FIG. 9 illustrates a perspective view of a crane hook rotator associated with the proposed device according to embodiments of the present invention disclosed herein;

FIG. 10 illustrates a perspective view of one of the hydraulic gripper associated with the device, indicating an alarming unit according to embodiments of the present invention disclosed herein;

FIG. 11 illustrates a front view of the device indicating plurality of components associated with the device according to embodiments of the present invention disclosed herein;

FIG. 12 illustrates a perspective view of a pair of hydraulic grippers associated with the proposed device according to embodiments of the present invention disclosed herein;

FIG. 13 illustrates a rear view of a hydraulic gripper associated with the device, indicating an axle according to embodiments of the present invention disclosed herein;

FIG. 14 illustrates a perspective view of one jaw of the hydraulic gripper associated with the proposed device, indicating plurality of individual mechanical clamp parts according to embodiments of the present invention disclosed herein; and

FIG. 15 illustrates a perspective view of the individual mechanical clamp parts associated with the device, indicating a sliding part according to embodiments of the present invention disclosed herein.

### DETAILED DESCRIPTION OF THE INVENTION

The following description includes the preferred best mode of one embodiment of the present invention. It will be clear from this description of the invention that the invention is not limited to these illustrated embodiments, but the invention also includes a variety of modifications and embodiments thereto. Therefore, the present description should be seen as illustrative and not limiting. While the invention is susceptible to various modifications and alternative constructions, it should be understood, that there is no intention to limit the invention to the specific form disclosed, but, on the contrary, the invention is to cover all modifications, alternative constructions, and equivalents falling within the scope of the invention as defined in the claims.

In any embodiment described herein, the open-ended terms “comprising,” “comprises,” and the like (which are synonymous with “including,” “having” and “characterized by”) may be replaced by the respective partially closed phrases “consisting essentially of,” consists essentially of,” and the like or the respective closed phrases “consisting of,” “consists of, the like.

As used herein, the singular forms “a”, “an”, and “the” designate both the singular and the plural, unless expressly stated to designate the singular only.

Unless otherwise defined, all technical and scientific terms used herein have the same meaning as commonly understood by one of ordinary skill in the art to which this invention belongs. The present invention disclosed herein is illustrative only and not intended to be limiting.

Embodiments of the present invention will be described below in detail with reference to the accompanying drawings.

The present invention is related to an adjustable gripping and handling device that revolutionizes material handling with its innovative design, seamlessly merging mechanical gripping and vacuum suction capabilities. The device provides the ability to adapt to diverse product sizes, ensuring efficient and safe handling in industrial and commercial environments. Moreover, the device offers a versatile and reliable solution for the challenges of modern material handling operations such as gripping, turning, lifting and transporting.

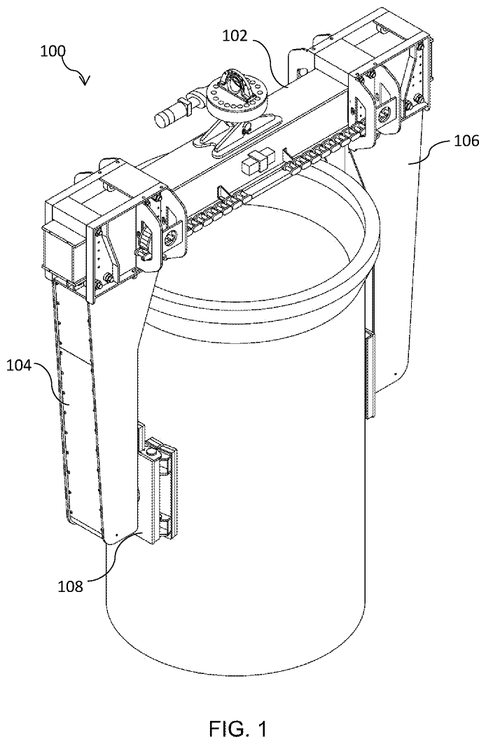

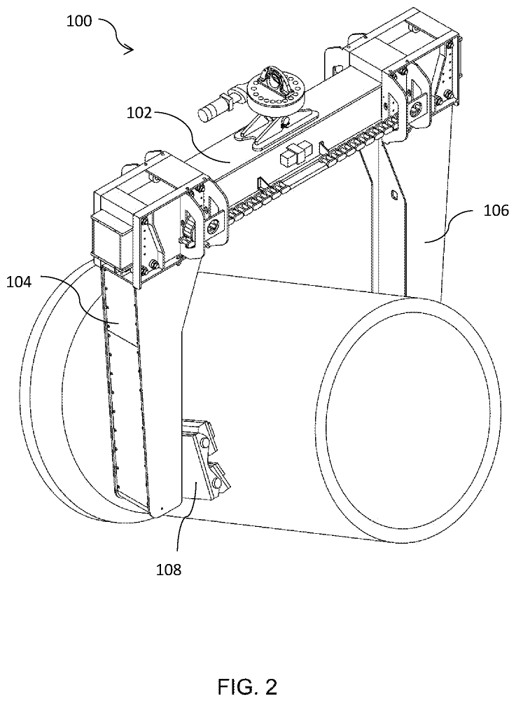

Referring to FIG. 1 and FIG. 2, a perspective view of an adjustable gripping and handling device 100 holding a typical concrete product and a perspective view of the proposed device 100 holding the product at different orientation are illustrated, respectively, representing a plurality of members including a horizontal member 102, a first vertical member 104, a second vertical member 106, and a hydraulic gripper 108 individually attached to the first vertical member 104 and the second vertical member 106. The first vertical member 104 and the second vertical member 106 have an anterior end and a posterior end, wherein the anterior end is connected to the horizontal member 102 via the slider mechanism. The first vertical member 104 and the second vertical member 106 are aligned parallel to each other and connected to the horizontal member 102 that provides stability and support while allowing adjustment of the gap between the first vertical member 104 and the second vertical member 106 via the slider mechanism. Further, a pair of hydraulic grippers 108 is individually attached to the posterior end of the first vertical member 104 and the second vertical member 106 via a chain rotation drive mechanism.

The slider mechanism herein allows the first vertical member 104 and the second vertical member 106 to slide towards each other and away from each other, which enables the adjustment of the gap between the first vertical member 104 and the second vertical member 106 to accommodate products of various sizes. This adjustment in the gap between first vertical member 104 and second vertical member 106 is based on the size of the product to be lifted.

According to one embodiment of the present invention, the size of the product is determined manually by the operator of the adjustable gripping and handling device 100 and accordingly adjustment in the gap between the first vertical member 104 and the second vertical member 106 is made.

In another embodiment of the present invention, the size of the product is determined automatically via a sensing module such as an ultrasonic sensor and/or laser sensor associated with the adjustable gripping and handling device 100. Herein, the ultrasonic sensor is pre-programmed to detect product diameter nominal (DN) size and wall thickness.

According to another embodiment of the present invention, the size of the product is determined automatically by an artificial intelligence imagining unit and accordingly adjustment in the gap between the first vertical member 104 and the second vertical member 106 is made. In an embodiment of the present invention, the slider mechanism is operated via a motor that is controlled by a microcontroller inbuilt within the adjustable gripping and handling device 100. Herein, the microcontroller is pre-programmed in a manner to coordinate the working of the component associated with the adjustable gripping and handling device 100 to perform gripping task and connected with a database stored with data related to safety factors for the safe handling of various products.

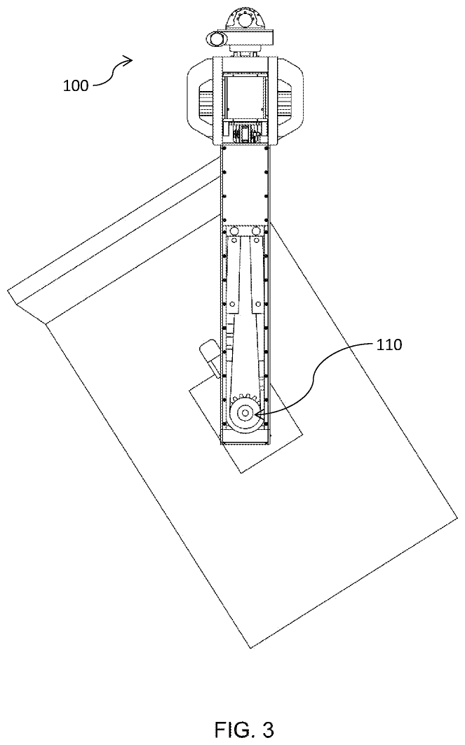

Referring to FIG. 3, a side view of the device 100 holding the product, indicating a chain rotation drive mechanism 110 is illustrated. Furthermore, the hydraulic gripper 108 is individually attached to posterior end of the first vertical member 104 and the second vertical member 106 by means of the chain rotation drive mechanism 110. In one embodiment of the present invention, the pair of hydraulic grippers 108 uses pressurized fluids to move a piston associated with the hydraulic grippers 108 and the movement of the piston, transfers the force to the jaws associated with the pair of hydraulic grippers 108 in view of opening and closing the jaws.

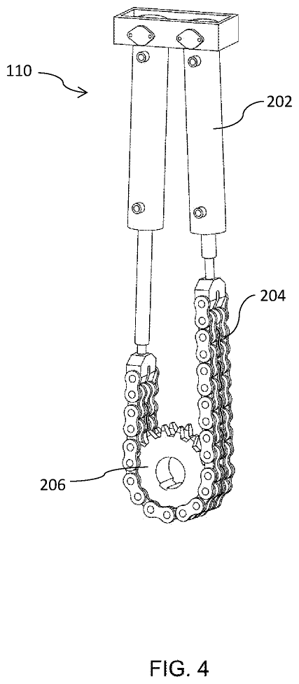

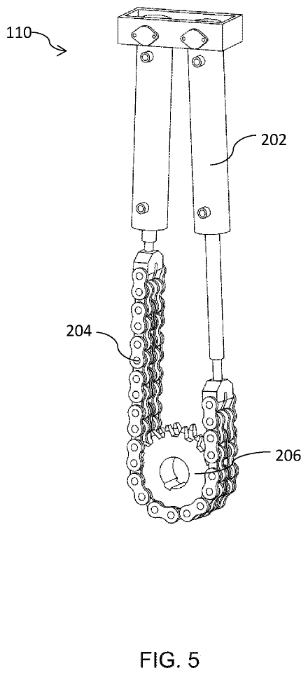

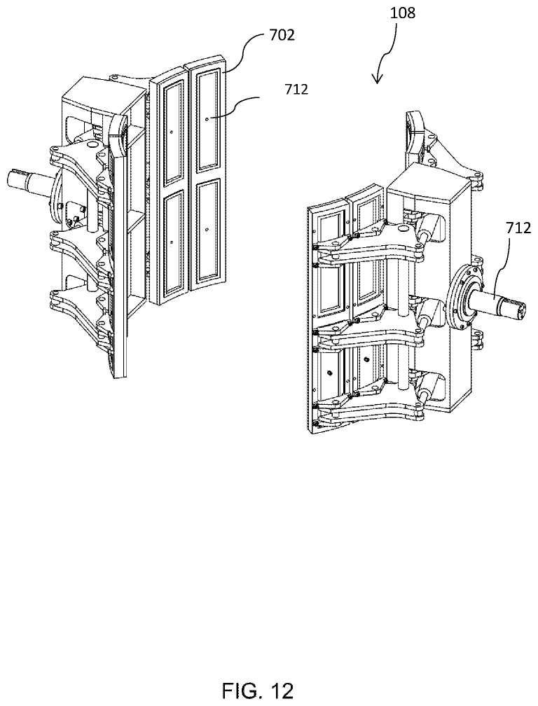

Referring to FIG. 4 and FIG. 5, a perspective view of the chain rotation drive mechanism 110 and a perspective view of the chain rotation drive mechanism 110, indicating extension and retraction of the pistons 202 that pull or release the chain 204 accordingly are illustrated. In one embodiment of the present invention, the chain rotation drive mechanism 110 comprises of a pair of hydraulic piston 202 connected to a hydraulic system, a loop of chain 204, a sprocket 206 and an axle 712 associated with the pair of hydraulic grippers 108 and configured with the sprocket 206 (read with FIG. 12). The hydraulic system's valve and controller regulate the flow and direction of hydraulic fluid to the pistons 202. When the pressurized hydraulic fluid is supplied to the pistons 202, they extend or retract depending on the direction of fluid flow. Each piston 202 is attached to one end of the loop of the chain 204 so that the extension and retraction of the pistons 202 pull or release the chain 204 accordingly. The links associated with the loop of the chain 204 is engaged with teeth of the sprocket 206 and further the sprocket 206 is connected to the axle 712 of the hydraulic gripper 108. When hydraulic fluid is supplied to the piston 202, one piston 202 extends while other retracts, causing the loop of chain to move in one direction.

The movement of the chain rotates the sprocket 206 along with the axle 712. The rotation of the axle 712 flips the product held by the hydraulic grippers 108 at 360 degree both clockwise and anticlockwise. The hydraulic system's valve and controller regulate the flow and direction of the hydraulic fluid to the pistons 202, allowing precise control over the movement of chain and the rotation of the hydraulic gripper 108 in view of controlling accurate flipping of the product as required. This chain rotation drive mechanism 110 provides a robust and efficient mechanism for rotating and revolving the product at desired orientation.

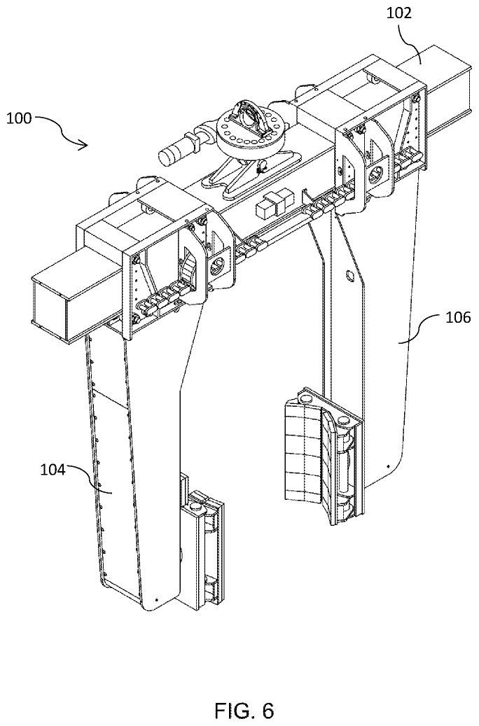

Referring to FIG. 6, a perspective view of the proposed device 100 indicating a first vertical member 104 and a second vertical member 106 is illustrated. In the embodiment, the first vertical member 104 and the second vertical member 106 are positioned on the horizontal member 102 at a distance.

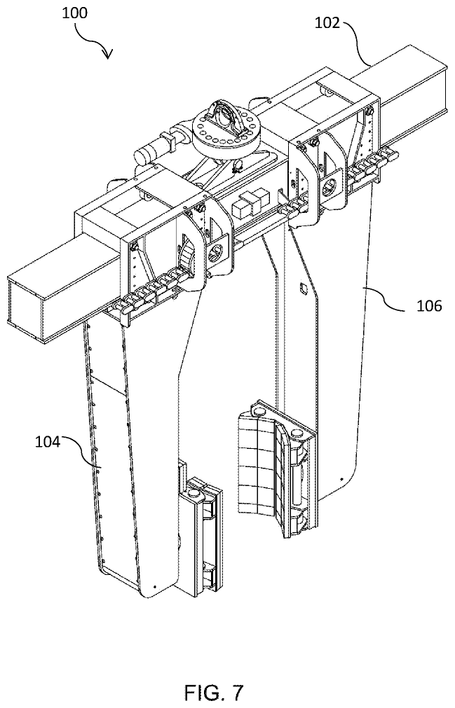

Referring to FIG. 7, a perspective view of the proposed device 100 indicating the first vertical member 104 and a second vertical member 106 at different location on a horizontal member 102 is illustrated. In the embodiment of the present invention, the first vertical member 104 and the second vertical member 106 are positioned on the horizontal member 102 at closer distance in comparison to FIG. 6.

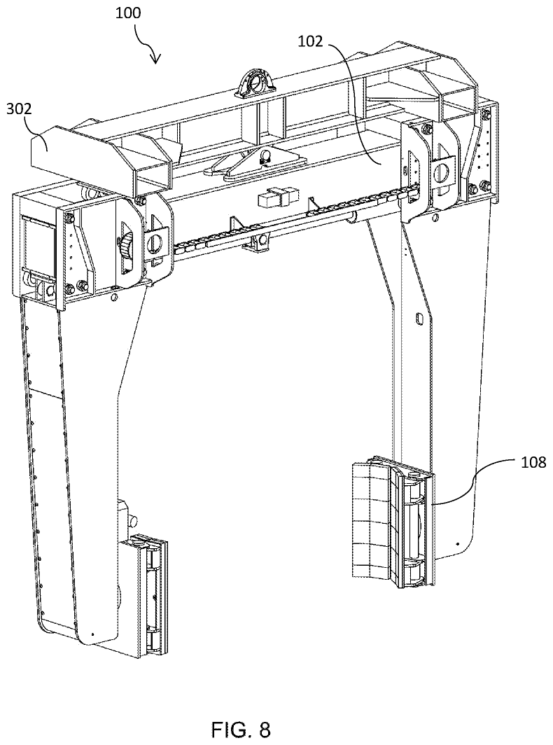

Referring to FIG. 8, a perspective view of the adjustable gripping and handling device 100, indicating a forklift carry beam 302 with anti-side swing support is illustrated. In an embodiment of the present invention, the proposed gripping device 100 discloses the forklift carry beam 302 configured on the horizontal member 102 to ensure proper alignment and stability of the proposed device 100, while lifting and transporting the product grabbed by the pair of hydraulic grippers 108 with a forklift. The forklift carry beam 302 is a horizontal structure with anti-side swing support that is attached to the forklift's forks, providing a stable platform for securing the load. In an embodiment of the present invention, the forklift carry beam 302 is configured with the anti-side swing support to prevent the present device 100 from swinging during lifting and transportation, which improves safety and efficiency. In one embodiment of the present invention, the anti-side swing support comprises of additional bracing or stabilizing mechanism that minimizes lateral movement of the forklift's fork. In one embodiment of the present invention, the anti-side swing support includes adjustable arms, clamps, or straps to secure the forklift's fork firmly in place, reducing the risk of tipping or shifting unexpectedly.

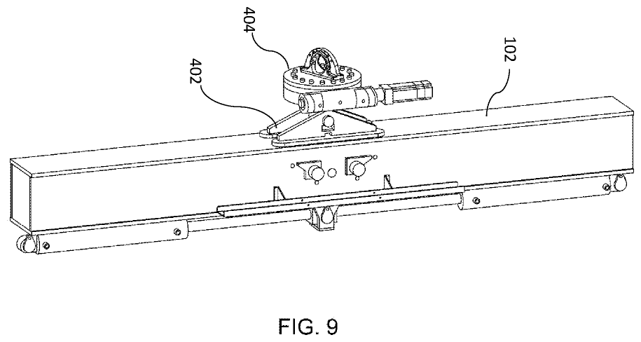

Referring to FIG. 9, a perspective view of a crane hook rotator 404 associated with the present device 100 is illustrated. In an embodiment of the present invention, the adjustable gripping and handling device 100 discloses the crane hook rotator 404 mounted on the horizontal member 102 via a pair of attachment member 402. The crane hook rotator 404 provides a means of attachment for the crane's hook that enables the crane operator to adjust the orientation of the proposed device 100 while the device 100 is suspended in the air. The crane hook rotator 404 provides greater control over the positioning of the product during lifting and placement operations. In one embodiment of the present invention, the crane hook rotator 404 is controlled manually. In another embodiment of the present invention, the crane hook rotator 404 is controlled electronically.

In one embodiment of the present invention, the crane hook rotator 404 is equipped with a load cell that works by using strain gauge to measure the amount of force applied to the hook. Herein, the amount of force applied to the hook is directly proportional to the weight of the proposed device 100 along with the product. When the proposed device 100 is attached to the hook, the load causes the hook to deform slightly, which changes the electrical resistance of the strain gauge. This change in resistance is then converted into an electrical signal proportional to the applied force, which is calibrated to provide an accurate weight reading of the load. In one embodiment of the present invention, the information related to the weight is typically displayed on a digital readout or transmitted to a control system for monitoring and recording purposes.

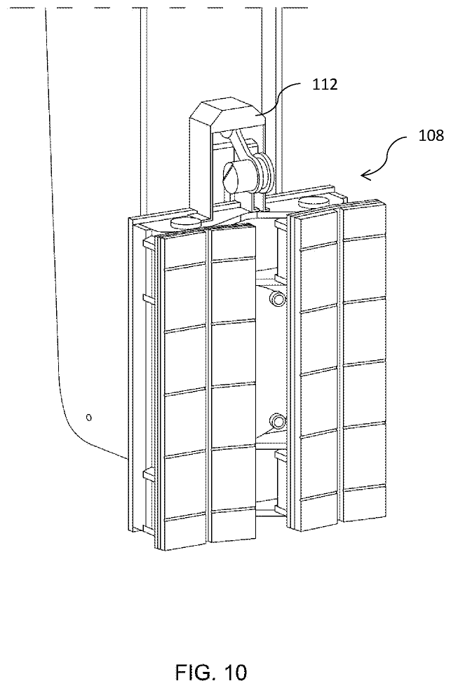

Referring to FIG. 10, a perspective view of one of the hydraulic grippers 108 associated with the device 100, indicating an alarming unit 112. In an embodiment of the present invention, the pair of hydraulic grippers 108 is integrated with a product slip detector. The product slip detector monitors the grip force applied to the product being held via a force sensor integrated into the pair of hydraulic grippers 108. The pair of hydraulic grippers 108 applies a certain amount of force to securely hold the product and the force that is being applied is measured continuously by the force sensor. In case, the microcontroller determines that the measured force is below compared with a pre-determined threshold value and pre-saved in the database connected to the microcontroller, the microcontroller activates the alarm unit 112 to alert operators. In one embodiment of the present invention, the microcontroller directs the pair of hydraulic grippers 108 for corrective actions, such as adjusting the grip force. In another embodiment of the present invention, the microcontroller halts the operation until the issue is resolved.

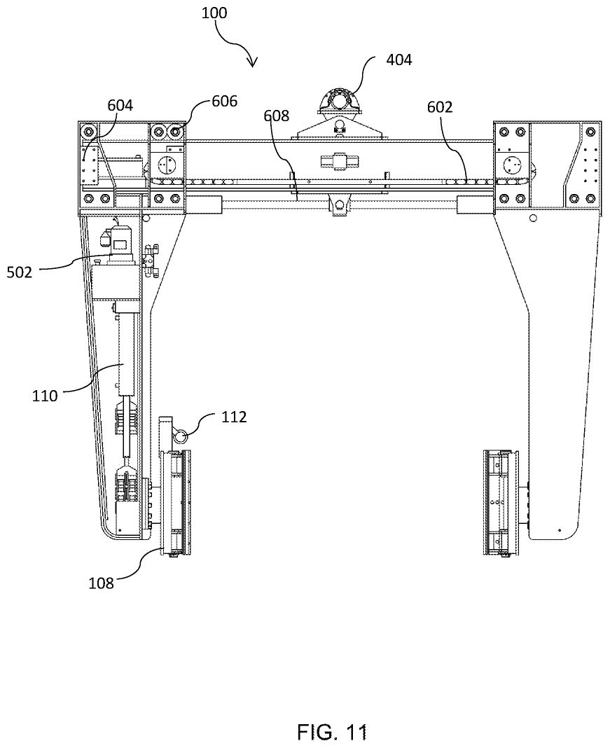

Referring to FIG. 11, a front view of the proposed device 100 indicating plurality of components associated with the device 100 is illustrated. In one embodiment of the present invention, the plurality of members is made up of high tensile steel construction. In one embodiment of the present invention, the first vertical member 104 and the second vertical member 106 are designed to be narrow to enable the first vertical member 104 and the second vertical member 106 to fit inside the hollow product. In one embodiment of the present invention, the first vertical member 104 and the second vertical member 106 are individually incorporated with a hydraulic power unit 502. In another embodiment of the present invention, the horizontal member 102 is configured with a pair of durable batteries (not shown in figures).

In an embodiment of the present invention, the proposed device 100 includes the plurality of components such as the slider mechanism, the hydraulic power unit 502, the chain rotation drive mechanism 110, the crane hook rotator 404, the pair of hydraulic grippers 108 and the alarming unit 112.

Referring to FIG. 11, an embodiment of the present invention, the slider mechanism includes several components such as a slider (not shown in figure), rails or tracks 602, bearings 606, fasteners 604, an actuator 608, and guides (not shown in figure). The slider associated with the slider mechanism is a rigid component that moves horizontally along the horizontal member 102 and serves as the main element for connecting the first vertical member 104 and second vertical member 106 for facilitating their movement towards and away from each other. Further, rails or tracks 602 are mounted on the horizontal member 102 for providing a stable path for the slider to move along. Wherein, guides associated with the slider mechanism help to maintain the alignment of the slider within the rails or tracks 602, preventing lateral movement and ensuring smooth operation. The rails ensure smooth and guided motion of the slider.

In one embodiment of the present invention, the guides are capable of being integrated into the slider. In another embodiment of the present invention, the guides are capable of being mounted separately on the first vertical member 104 and the second vertical member 106. The bearings 606 are used to reduce friction between the slider and the rails, enabling smooth movement. In one of the embodiments, the bearing 606 includes ball bearings, roller bearings, or sliding bearings depending on the application requirements. The fasteners 604 are used to securely attach the rails to the horizontal member 102 and the vertical members 104, to the slider. The fastener 604 ensures the stability and integrity of the slider mechanism. In one embodiment of the present invention, the fasteners 604 include screw, bolts and/or brackets. The actuator 608 associated with the slider mechanism is responsible for initiating and controlling the movement of the slider.

In an embodiment of the present invention, the operation of the actuator 608 is manually operated, such as via a handle or lever. In another embodiment of the present invention, the operation of the actuator 608 is automatically operated, such as via a motor or pneumatic/hydraulic cylinder. The components associated with the slider mechanism work together to enable the smooth and controlled movement of the parallelly aligned first vertical member 104 and second vertical member 106 towards and away from each other over the horizontal member 102, providing adjustable spacing as per the size of the product to be lifted.

Referring to FIG. 12, a perspective view of the pair of hydraulic grippers 108 associated with the proposed device 100, indicating the axle 712 is illustrated. In the embodiment, the pair of hydraulic grippers 108 is individually configured with the axle 712 that is to be fitted within the sprocket 206 associated with the chain rotation drive mechanism 110. The pair of hydraulic grippers 108 is configured with a plurality of individual mechanical clamp parts 702.

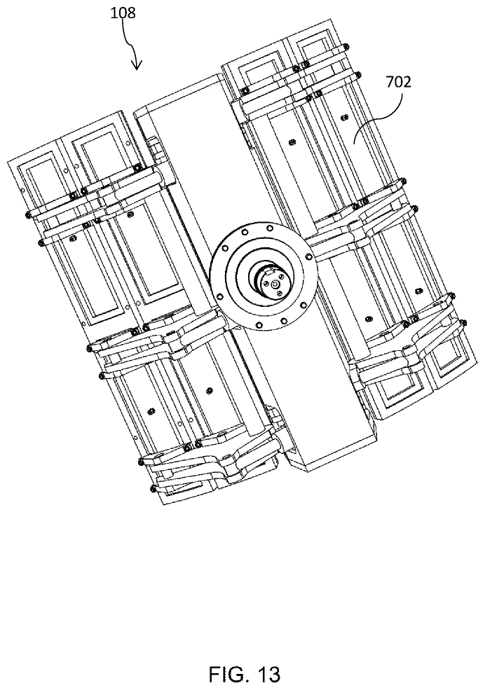

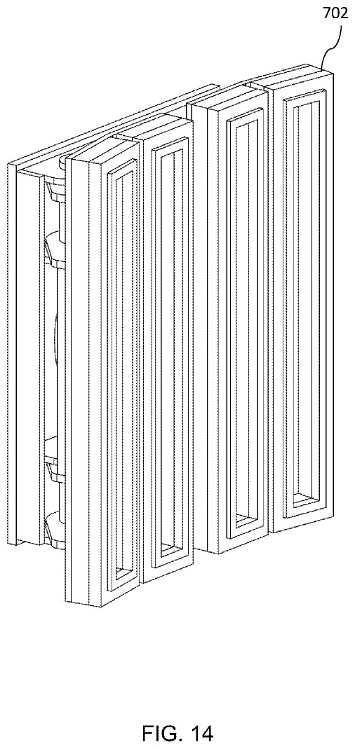

Referring to FIG. 13 and FIG. 14, a rear view of a hydraulic gripper 108 associated with the device 100 and a perspective view of one jaw of the hydraulic gripper 108 associated with the proposed device 100, indicating plurality of individual mechanical clamp parts 702 are illustrated. In the embodiment, the plurality of individual mechanical clamp parts 702 are attached to the pair of jaws associated with the pair of hydraulic grippers 108.

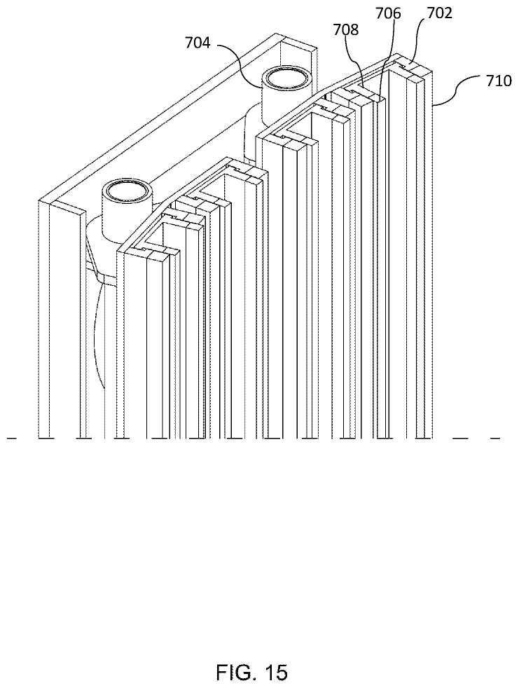

Referring to FIG. 15, a perspective view of one of the mechanical clamp parts 702 associated with the device 100, indicating a sliding part 708 is illustrated, representing sliding parts 708 and the universal joints 704. In the embodiment of the present invention, the plurality of mechanical clamp parts 702 is arranged on one of the jaw associated with the hydraulic gripper 108 by means of plurality of universal joints 704 for enabling adjustment in the orientation of the individual mechanical clamp parts 702

In one embodiment of the present invention, the plurality of mechanical clamp parts 702 is configured to have a contact surface fabricated with the gripping pads 710. The gripping pads 710 are made up of rubber or polyurethane (PU) to enhance the grip on the product. Furthermore, a universal joint 704 is incorporated between the mechanical clamp parts 702 and the hydraulic grippers 108 for tilting each of the mechanical clamp parts 702 in a required direction. Wherein, the universal joints 704 allow movement of the plurality of individual mechanical clamp parts 702 in a pre-defined range in order to enable alignment of contact surface in the direction of the product that is to be gripped.

In the embodiment of the present invention, the plurality of individual mechanical clamp parts 702 houses the sliding parts 708 configured with floating vacuum cup foam 706. Wherein, the sliding parts 708 installed within each of the individual mechanical clamp parts 702 facilitate the movement of the vacuum cup foam 706 and the foam 706 provides a stable and adaptable surface for vacuum suction. Further, each sliding parts 708 are configured with a vacuum port connected to a vacuum pump or pre-charged tank to enable vacuum suction. This enables the device 100 to switch between mechanical gripping and vacuum suction as required for handling different types of products. Handling operation includes lifting, rotating, turning and transporting products of varying sizes and shapes.

According to yet another embodiment of the present invention, the adjustable gripping and handling device 100 is capable of activation of mechanical gripping and vacuum suction gripping at the same time as required for handling different types of products.

Therefore, the combined mechanical and vacuum gripping device 100 described herein offers a versatile solution for handling various products in industrial and commercial settings. By combining mechanical grippers with vacuum suction capabilities, the device 100 ensures secure and efficient lifting, contributing to increased productivity, safety and efficiency in material handling operations.

New characteristics and advantages of the invention covered by this document have been set forth in the foregoing description. It is to be expressly understood, however, that the expressions used in foregoing are for the purpose of illustration only and are not intended as a definition of the limits of the invention. Changes in the specification are capable of being made in detail without exceeding the scope of the invention by those who are skilled in the art. The scope of the invention is described in the appended claims hereinafter.

What is claimed is:

1. An adjustable gripping and handling device, the device comprises of:
a plurality of members comprising:
a horizontal member having a first end and a second end;
a plurality of vertical members consisting of a first vertical member and
a second vertical member, the each of the plurality of vertical members comprises an anterior end and a posterior end;
wherein the anterior end of the plurality of vertical member is connected to the horizontal member via a slider mechanism; and
the posterior end of the plurality of vertical member comprises a hydraulic gripper configured with a chain rotation drive mechanism;
wherein each of the hydraulic gripper is configured with a plurality of mechanical clamp parts having a contact surface fabricated with a plurality of gripping pads;
wherein each of the plurality of mechanical clamp parts houses a sliding part configured with floating vacuum cup foam and a vacuum port for enabling mechanical and vacuum gripping to grip a plurality of diverse products.

2. The device as claimed in claim 1, wherein the vacuum port is connected to a vacuum pump or pre-charged tank.

3. The device as claimed in claim 1, wherein the slider mechanism is configured to adjust the gap between the first vertical member and the second vertical member.

4. The device as claimed in claim 1, wherein the slider mechanism comprises a slider, rails or tracks, bearings, fasteners, an actuator, and guides.

5. The device as claimed in claim 1, wherein the chain rotation drive mechanism comprises a pair of hydraulic pistons connected to a hydraulic system, a loop of chain, a sprocket configured with an axle associated with the hydraulic gripper.

6. The device as claimed in claim 1, wherein the plurality of gripping pads is made up of rubber or polyurethane.

7. The device as claimed in claim 1, wherein the horizontal member is mounted with a crane hook rotator via a pair of attachment member for enabling a crane operator to attach the crane's hook and adjust the orientation of the gripping device while being suspended in the air during product transportation.

8. The device as claimed in claim 7, wherein the crane hook rotator is configured with a load cell to measure the amount of force applied to the crane's hook.

9. The device as claimed in claim 1, wherein the horizontal member is configured with a forklift carry beam with anti-side swing support to ensure proper alignment and stability when lifting and transporting the product with a forklift.

10. The device as claimed in claim 1, wherein a force sensor is integrated with the pair of hydraulic grippers for detecting gripping force.

11. The device as claimed in claim 1, wherein the pair of hydraulic grippers is configured with a product slip detector for detecting insufficient gripping force.

12. The device as claimed in claim 1, wherein an alarming unit is configured to alert an operator when insufficient gripping force is applied to the plurality of diverse products.

13. The device as claimed in claim 1, wherein the plurality of sliding parts freely moves within the housing of the mechanical clamp parts.

14. An adjustable gripping and handling device for an object, the device comprises of:
a plurality of members comprising:
a horizontal member having a first end and a second end;
a plurality of vertical members consisting of a first vertical member and
a second vertical member, the each of the plurality of vertical members comprises an anterior end and a posterior end;
wherein the anterior end of the plurality of vertical member is connected to the horizontal member via a slider mechanism; and
the posterior end of the plurality of vertical member comprises a hydraulic gripper configured with a chain rotation drive mechanism;
wherein each of the hydraulic gripper is configured with a plurality of mechanical clamp parts; and
each of the plurality of mechanical clamp parts has a housing to accommodate a free floating sliding part.

15. The device as claimed in claim 1, wherein a contact surface of the plurality of mechanical clamp parts is fabricated with a plurality of gripping pads.

16. The device as claimed in claim 1, wherein the sliding part is configured with floating vacuum cup foam and a vacuum port for enabling mechanical and vacuum gripping of a product.
